(19) United States
(12) Patent Application Publication
(10) Pub. No.: US 2008/0241495 A1
(43) Pub. Date: Oct. 2, 2008

(54) Magnetic Publication Apparatus

(76) Inventor: Ruth Corla DeBro, Los Angeles, CA (US)

Correspondence Address: WASSERMAN, COMDEN & CASSELMAN, L.L.P., 5567 RESEDA BOULEVARD, SUITE 330, TARZANA, CA, 91357-7033, US

(21) Appl. No.: 11/690,967

(22) Filed: Mar. 26, 2007

(51) Int. Cl. B32B 9/04

(52) U.S. Cl. 428/220; 428/323; 428/411.1

(57) ABSTRACT

A magnetic publication apparatus is provided. The magnetic publication apparatus is comprised of a magnetic layer, which contacts a support containing a magnetic component, a substrate layer which contacts the magnetic layer, a publication layer, including a graphic, which serves as a guide for publication, and contacts the substrate layer, and a impervious film layer which contacts the substrate and publication layers, and allows for marking.

### BACKGROUND OF THE INVENTION

1) Field of the Invention

The invention relates to substrates for marking. Specifically, the invention relates to a publication apparatus used in conjunction with surfaces containing a magnetic component.

2) Discussion of the Related Art

Dry-erase boards are a well-known method for writing information temporarily. Dry-erase boards are commonly used in offices, schools, and other locations. The dry-erase surfaces generally include an enamel film, melamine, acrylic, vinyl chloride, polypropylene, polyethylene, polyethylene, polystyrene, cellulose acetate, polyurethane, porcelain, high pressure laminate or resin layer affixed to a backing.

Dry-erase boards or “substrates” are characterized in that they have hard, white surfaces that are very smooth in appearance, and are essentially nonporous. Specially designed markers are used to write on the substrate. While the ink of the marker dries on the substrate, the ink does not bond to the substrate surface and the writing may be easily removed with a soft eraser, cloth, finger, or similar.

Currently, dry-erase boards include a magnetic component. The magnetic component is seen in U.S. Pat. No. 7,119,048 to Staadecker, and enables the board to receive and hold magnets. Magnetic materials have been previously used in connection with erasers for dry-erase boards, but only Thorp, U.S. Pat. No. 5,836,038, discloses, a magnetic mount dry-eraser. The eraser contains magnetic material that secures the eraser to a metallic surface that is mounted on a surface of the dry-erase board.

The disadvantages of the current art are the inability to meet the versatile needs of the classroom. The prior art is unable to be portable. Portability is needed in the classroom to provide the student the means to work in other locations, so as to not have to work directly on the dry-erase board. This problem becomes apparent where a large group is participating in a given project and dry-erase board space is limited. The prior art also lacks the ability to magnetically connect or “publish” the sample after completion on the dry-erase board.

Maneuverability is also a feature the prior art does not provide. This characteristic is needed in situations where a large number of students are participating on a given dry-erase board. This would allow each user the ability to maximize space on the dry-erase board and prevent information on the board from being erased when that information is crucial to the lesson.

### BRIEF DESCRIPTION OF THE DRAWINGS

The invention is described by way of example with reference to the accompanying drawings wherein:

FIG. 1 is a front perspective view of a magnetic publication apparatus.

FIG. 2 is a cross-sectional perspective of the magnetic publication apparatus illustrating a connectivity of layers.

FIG. 3 is a cross-sectional perspective of the magnetic publication apparatus, including an at least one side formed in a concave shape.

FIG. 4 is a front perspective of the magnetic publication apparatus, substantially elongated.

FIG. 5 is a top perspective of the magnetic publication apparatus in flexible form.

FIG. 6 is a front perspective of a film layer, including a magnetic strip.

### DETAILED DESCRIPTION OF THE INVENTION

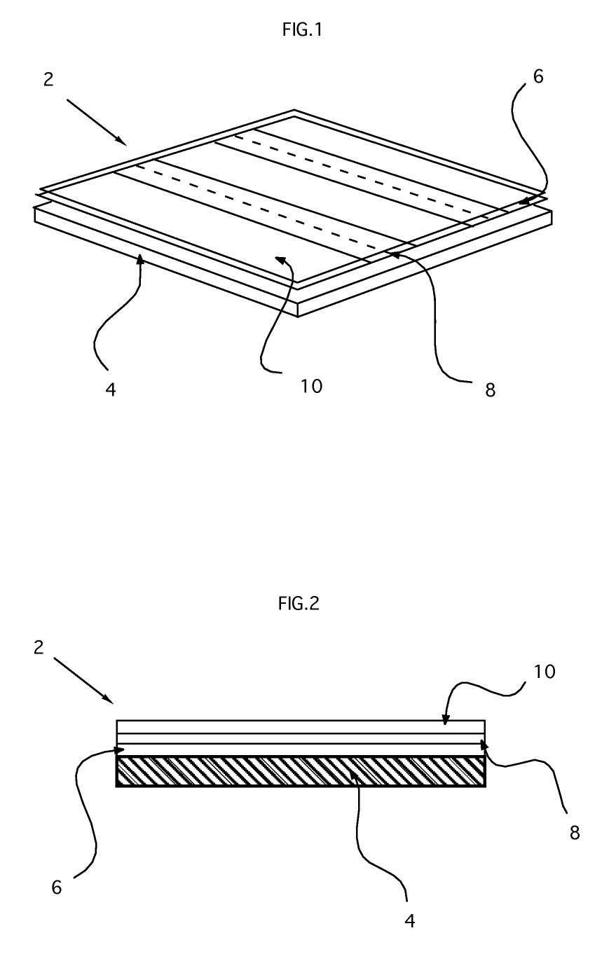

FIG. 1 of the accompanying drawings illustrates a magnetic publication apparatus 2. The magnetic publication apparatus 2 includes, a magnetic layer 4, a substrate layer 6, a publication layer 8, and a film layer 10.

FIG. 2 is a cross-sectional perspective of the magnetic publication apparatus 2, illustrating a connectivity of layers. The magnetic layer 4 magnetically contacts a support containing a magnetic component. The substrate layer 6 contacts the magnetic layer 4. The publication layer 8 contacts the substrate layer 6, providing a surface and guide for writing, respectively. A film layer 10 contacts the substrate and publication layers, 6 and 8, respectively, and contains an impervious film. The film layer 10 may be marked on by specifically designed markers, which do not bond or penetrate, and are easily erased.

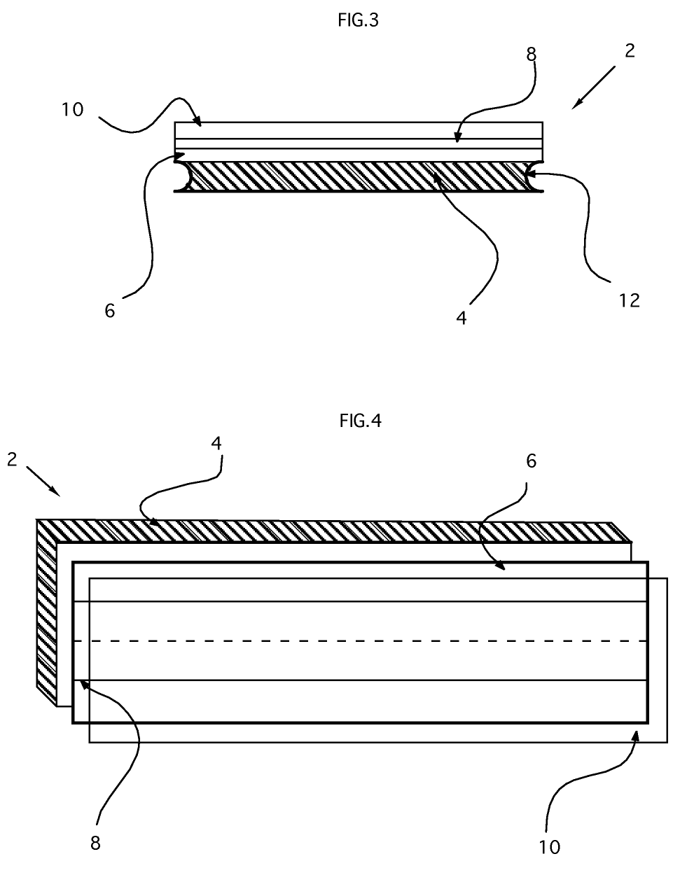

FIG. 3 is a cross-sectional perspective of the magnetic publication apparatus 2, according to an embodiment of the invention. The magnetic publication apparatus 2 includes an at least one side formed in a concave shape 12. In another embodiment, the magnetic publication apparatus 2 contains a fastener that aids in retaining tools used in conjunction with the apparatus.

FIG. 4 is a front perspective of the magnetic publication apparatus 2, substantially elongated, illustrating a ratio of length to width of the magnetic, substrate, publication and film layers, 4, 6, 8, and 10, respectively, where the length is substantially greater than the width, according to one embodiment. In another embodiment, the length to width is approximately 44 to 3¾ inches, respectively. In another embodiment, the ratio of length to width is 12:1.

FIG. 5 is a top perspective of the magnetic publication apparatus 2. FIG. 5 illustrates the magnetic publication apparatus 2, including the magnetic, substrate, publication and film layers, 4, 6, 8 and 10, respectively, in a flexible form. The flexible form allows the magnetic publication apparatus 2 to be folded, or in any other configuration, which provides ease of transportation, storage and use.

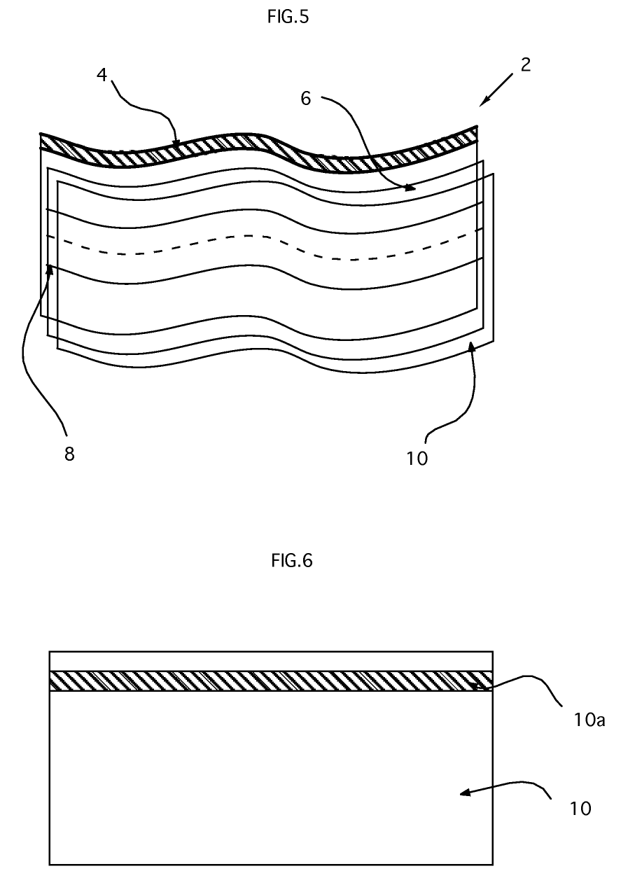

FIG. 6 is a front perspective of the film layer 10, and in one embodiment, includes a magnetic strip 10a. The magnetic strip 10a provides a user the ability to detach the film layer 10 from the magnetic publication apparatus 2 and use the film on an overhead projector or equivalent machine.

In use, the magnetic layer 4 of the magnetic publication apparatus 2 magnetically contacts a support containing a magnetic component. In one embodiment, the magnetic publication apparatus 2 includes an at least one side formed in a concave shape 12 and thickness of at least one-quarter inch. The concave feature provides the ability to store a writing utensil(s), which is used in conjunction with the current invention.

The substrate layer 6 contacts the magnetic layer 4, and the publication layer 8 contacts the substrate layer 6. The substrate 6 and publication 8 layers provide a surface and guide for writing, respectively. In one embodiment, the publication layer 8 is comprised of a graphic, including a lined-paper formatted template provides the user the ability to handwrite effectively and to publish information to an audience in a classroom environment. A multitude of other graphics may be used in the publication layer 8, including maps, charts, graph paper and other pictures. The publication layer 8 may also comprise a printed board, and by silk-screening or printing with inks, produce graphics on the printed board, which are indelible.

In another embodiment, the substrate layer 6 and said publication layer 8 are comprised of opposing colors, or contrasting colors. Color combination(s) are crucial in publishing the users handwriting sample to an audience where distances to the front of the class are great enough to diminish viewing. Contrasting colors are complimentary colors that are opposites, which include, yellow and purple or red and green. Opposing colors include red, yellow, and blue. The colors, when used properly, create a visual appearance that enhances viewing.

The film layer 10 contacts the substrate and publication layers, 6 and 8, respectively. The film layer is transparent and impervious, providing the ability to withstand impregnation by the marker or writing utensil. The user writes on the film layer 10, and is guided by the present template or graphic publication layer 8, which is supported by the substrate layer 6.

In one embodiment, the film layer 10 is removable and includes a magnetic strip 10a. The magnetic strip 10a provides a user the ability to detach the film layer 10 from the magnetic publication apparatus 2 and use the film on an overhead projector or equivalent machine. The removable film layer 10 also allows the user to modify or replace the publication layer 8, thus coordinating the apparatus with the current lesson, and may include a plurality of magnetic strips to improve adhesion.

The magnetic, substrate, publication and film layers, 4, 6, 8 and 10, respectively, are substantially equal and contacting one another. In one embodiment, the substrate, publication and film, 6, 8 and 10, respectively, are substantially equal, exposing the magnetic layer 4. The exposed portions of the magnetic layer 4 provide the user the ability to post magnetic tools and other equipment that contains a magnet component.

Many classrooms include a dry-erase board and many dry-erase boards include a magnetic component. The magnet component provides the ability to adhere magnetic eraser, letters and clips to the board. An advantage of the invention is the ability to provide a user a portable publication tool, allowing the user the ability to write and instantly publish on the dry-erase board. Moreover, the invention allows for the maneuverability of the publication, so information crucial to the lesson does not need to be erased in order to make space.

Another advantage of the invention is the creation of the publication layer insert. The layer may include many types of graphics that are pertinent in subjects taught in the classroom or given during a presentation, and given the size of the apparatus the publication remains large enough to be visible in a classroom setting.

Many classrooms use overhead projectors. Another advantage of this invention is the magnetic strip that is present on the film layer. The magnetic strip allows the user to remove the film layer from the magnetic publication apparatus and place it over an overhead projector or equivalent machine that reads transparencies.

The advantages of the invention are tailored to provide the user the ability to write and publish instantly, in a manner consistent with a dry-erase board, but retain the portability and maneuverability needed in today's classrooms. Moreover, the versatility present in the invention allows the user the ability to include multiple graphics within the publication layer, and the information written thereon, be used with other classroom or presentation equipment.

While certain exemplary embodiments have been described and shown in the accompanying drawings, it is to be understood that such embodiments are merely illustrative and not restrictive of the current invention, and that this invention is not restricted to the specific constructions and arrangements shown and described since modification may occur to those ordinarily skilled in the art.

What is claimed:

1. A magnetic publication apparatus, comprising:
a magnetic layer, said magnetic layer contacting a support containing a magnetic component;
a substrate layer contacting said magnetic layer;
a publication layer contacting said substrate layer; and
a impervious film layer contacting said substrate and publication layers.

2. The magnetic publication apparatus of claim 1, wherein said apparatus is flexible.

3. The magnetic publication apparatus of claim 1, wherein an at least one side of said apparatus is concave.

4. The magnetic publication apparatus of claim 3, wherein said at least one side of said apparatus includes a depth of at least a one-quarter inch.

5. The magnetic publication apparatus of claim 1, wherein said publication layer is comprised of a graphic.

6. The magnetic publication apparatus of claim 1, wherein said magnetic, substrate, publication and film layers are substantially equal.

7. The magnetic publication apparatus of claim 1, wherein said film layer includes a magnetic strip.

8. The magnetic publication apparatus of claim 1, wherein said magnetic publication apparatus is substantially elongated, including a length of approximately 44 inches and a width of 3¾ inches.

9. The magnetic publication apparatus of claim 1, wherein said substrate layer and said publication layer are comprised of opposing or contrasting colors.

10. A flexible magnetic publication apparatus, comprising:
a magnetic layer, said magnetic layer contacting a support containing a magnetic component;
a substrate layer contacting said magnetic layer;
a publication layer contacting said substrate layer, said publication layer including a lined-paper graphic; and
a impervious film layer contacting said substrate and publication layers.

11. The magnetic publication apparatus of claim 10, wherein an at least one side of said magnetic publication apparatus includes a concave surface.

12. The magnetic publication apparatus of claim 11, wherein said magnetic publication apparatus includes a depth of at least one-quarter inch.

13. The magnetic publication apparatus of claim 10, wherein said magnetic, substrate, publication and film layers are substantially equal.

14. The magnetic publication apparatus of claim 10, wherein said film layer includes a magnetic strip.

15. The magnetic publication apparatus of claim 10, wherein said magnetic publication apparatus is substantially elongated, including a length that is greater than a width of said apparatus.

16. The magnetic publication apparatus of claim 10, wherein said substrate layer and said publication layer are comprised of opposing or contrasting colors.

17. A method for publishing information, said method comprising:
contacting a magnetic publication apparatus to a support containing a magnetic component, said magnetic publication apparatus comprising, a magnetic layer contacting said support containing a magnetic component, a substrate layer contacting said magnetic layer, a publication layer, including a lined-paper graphic, contacting said substrate layer, a impervious film layer contacting said substrate and publication layers; and
writing on said film layer using a dry-erase marker, guided by said publication layer.

18. The method of publishing information of claim 17, wherein an at least one side of said magnetic publication apparatus includes a concave surface, including a depth of at least one-quarter inch.

19. The method of publishing information of claim 18, wherein said magnetic, substrate, publication and film layers are substantially equal.

20. The method of publishing information of claim 19, wherein said film layer includes a magnetic strip.
